(19) United States
(12) Patent Application Publication
(10) Pub. No.: US 2004/0254753 A1
(43) Pub. Date: Dec. 16, 2004

(54) Multimedia auditory test instrument

(75) Inventor: Stefan Bengtsson, Smoerum (DK)

Correspondence Address: David G. Beck, Bingham McCutchen LLP, 18th Floor, Three Embarcadero Center, San Francisco, CA, 94111, US

(73) Assignee: GN ReSound A/S

(21) Appl. No.: 10/799,899

(22) Filed: Mar. 12, 2004

Related U.S. Application Data
(60) Provisional application No. 60/459,794, filed on Apr. 2, 2003.

(51) Int. Cl. G01M 1/14; G01V 13/00; G01N 29/00

(52) U.S. Cl. 702/103; 381/58; 73/1.82

(57) ABSTRACT

An auditory instrument that includes a plurality of loud speakers is provided. Typically five speakers are used, although both fewer and greater numbers of speakers can be used depending upon the desired sound field quality as well as the desired system complexity and cost. The speakers can be wired or wirelessly connected to the audiometer. The system can be configured to provide automatic speaker calibration, thereby minimizing the effects of the speakers, speaker placement, and environmental characteristics. The speakers, in conjunction with the audiometer, are used during patient testing and hearing instrument evaluation. As part of the evaluation, the system can be used to reproduce typical sound fields.

### FIELD OF THE INVENTION

The present invention relates generally to auditory test instruments and, more particularly, to a multimedia auditory test instrument that can be used to evaluate a person's hearing, simulate a hearing loss, simulate the benefit of a hearing instrument, aid in fitting a hearing instrument, and simulate a typical sound environment.

### BACKGROUND OF THE INVENTION

Hearing impairment is quite common, especially among the elderly. In order to correct impaired hearing, extensive testing is required, thus allowing the exact nature of the impairment to be determined. Once determined, the patient must be fit with an appropriate hearing aid. During the fitting process, a sound simulator may be used to allow the patient to hear the benefits of the fitted hearing aid. Additionally, the sound simulator may be used prior to fitting in order to simulate non-impaired hearing.

Auditory test instruments are used to test the hearing capabilities of a person. Generally such instruments are designed to be mounted to, or maintained on, a desktop. Auditory test instruments often include a display, thus allowing the user to configure the instrument, set the test procedure and/or view the test results. A printer may also be included, thus allowing a hard copy of the test results to be printed. The instrument may also be capable of being connected, for example via an RS-232 connection, to a network, external computer or printer. Examples of such auditory test instruments are those manufactured by GN Otometrics under the Danplex, Madsen, Rastronics, Hortmann and ICS Medical brands.

Traditionally, sound simulation used for hearing assessment, either prior to or subsequent to the fitting of a hearing aid, utilized conventional audiometers. Such an approach, however, suffers from a variety of problems that result from (i) the phase relationship of the presented signals, (ii) localization effects, and (iii) lack of environmental effects (e.g., acoustic properties of the environment, competing sounds, etc.).

Another approach to providing sound simulation uses speakers situated throughout the testing room. Typically one set of speakers are used during testing: a pair of speakers for free field audiometry and a single speaker for measuring frequency response. Additionally, a second set of two or more speakers may be used to simulate a typical environment. If these speakers are not properly calibrated, including proper placement and orientation, the test results may be of limited value.

Accordingly, there is a need for a test instrument that overcomes the disadvantages of the previous test instruments while offering expanded capabilities. The present invention provides such a device.

### SUMMARY OF THE INVENTION

The present invention provides an auditory instrument that includes a plurality of loud speakers. Typically five speakers are used, although both fewer and greater numbers of speakers can be used depending upon the desired sound field quality as well as the desired system complexity and cost. The speakers can be wired or wirelessly connected to the audiometer. The system can be configured to provide automatic speaker calibration, thereby minimizing the effects of the speakers, speaker placement, and environmental characteristics. The speakers, in conjunction with the audiometer, are used during patient testing and hearing instrument evaluation. As part of the evaluation, the system can be used to reproduce typical sound fields.

A further understanding of the nature and advantages of the present invention may be realized by reference to the remaining portions of the specification and the drawings.

### BRIEF DESCRIPTION OF THE DRAWINGS

FIG. 1 is a block diagram of a multimedia audiometer testing system in accordance with one embodiment of the invention.

### DESCRIPTION OF THE SPECIFIC EMBODIMENTS

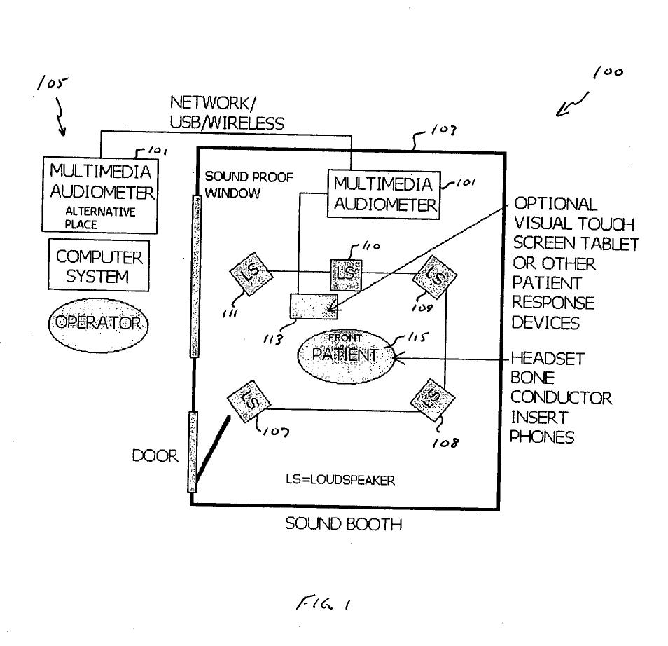

FIG. 1 is a block diagram of a multimedia auditory test instrument system 100 in accordance with one embodiment of the invention. System 100 includes an audiometer 101 that can either be located within testing room 103 or located externally to the testing room (e.g., at location 105). Coupled to audiometer 101 are multiple loudspeakers 107-111.

In a preferred embodiment, audiometer 101 also includes a patient response means 113, thus allowing patient feedback to be obtained. Patient response means 113 may be comprised of a touch sensitive screen, keyboard, etc.

Audiometer 101 is preferably portable although in at least one embodiment of the invention it is large enough to require desk top mounting. Within audiometer 101 is a diagnostic subsystem which can be configured for either screening or diagnostic testing. The diagnostic subsystem provides the means to test the desired auditory function as well as gather the resultant response data. Preferably this subsystem is modular and removably connected within instrument 101, thus allowing its easy removal and replacement to aid in instrument repair and/or reconfiguration. In general, the diagnostic subsystem is configured to offer a range(s) of frequencies and/or discrete frequencies of varying intensities and pressures, thus allowing various hearing disorders to be screened and analyzed. As various audiometric tests and the components needed to perform such tests are well known by those of skill in the art, a detailed description of each possible configuration of the diagnostic subsystem is not provided herein.

Audiometer 101 includes a processor. As used herein, the term processor refers to processors, digital signal processors (DSPs), microprocessors, CPUs, application specific integrated circuits (ASICs), etc. The processor is used to implement tests, analyze test results, and, in general, manage audiometer 101's operation. It will be appreciated that audiometer 101 can utilize a single processor or multiple processors.

Integrated into audiometer 101 is a memory. The memory is used to store user preferences in general and test parameters in particular. Preferably the memory is also used to store test data (e.g., current test results, previous test results, standardized test results, etc.). In addition, preferably the memory is used to store patient information (e.g., patient profiles, medical data, past test results, billing information, etc.), office management data (e.g., employee files, appointment records, supply records, payroll records, etc.), and communication protocols with wirelessly connected devices. The memory can be comprised of non-volatile memory (e.g., ROM), volatile memory (e.g., RAM) or both.

Audiometer 101 includes a user interface, thus providing a means of setting up the basic operation of instrument (e.g., operational language, display format, input means and display, etc.), entering commands, inputting test parameters, controlling testing, analyzing and/or reviewing test results, etc. In the preferred embodiment, the user interface also provides a means by which the user can enter and/or access individual patient data (e.g., patient profile, previous test data, etc.) as well as other office management tools (e.g., patient management tools, data storage, patient histories, patient appointment schedules, patient contact information, patient billing information, etc.). The user interface includes an input means comprised of any combination of buttons, switches, rotating/scrolling wheels, etc. In at least one embodiment, the input means includes a virtual keyboard, preferably an alphanumeric keyboard, graphically displayed on a touch sensitive display. The input means can also include a microphone for use in dictating, preparing voice files for attachment to test data, communicating with office personnel, etc. Preferably the user interface also includes a display means that can be used to provide the user with various types of information relating to both the configuration and functionality of audiometer 101. For example, the display means can be used in conjunction with the input means to configure audiometer 101, monitor instrument performance, select an auditory test, select the desired test parameters, etc. In a preferred embodiment, the display means is used to communicate test results, either textually or graphically, to the user. In another preferred embodiment, the display is used to present the user with patient data (e.g., patient profile, previous test data, etc.) and/or office management information (e.g., appointment schedules, patient and/or supplier contact information, invoice information, etc.). The display means can utilize various screen sizes and resolutions, depending upon power system constraints, expected tests, desired presentation formats, etc. Preferably the display means uses organic light emitting diodes (OLED), although other types of technology can be used (e.g., liquid crystal display (LCD) technology, light emitting polymers (LEP), electroluminescent (EL) or active matrix electroluminescent (AMEL) technology, organic thin film transistors (organic TFT), amorphous silicon integrated displays (ASID), pliable display technology (PDT), etc.).

Coupled to audiometer 101 is a probe. Preferably the probe is coupled to audiometer 101 by a flexible cable. Preferably the probe is easily detached, thus allowing it to be quickly replaced with other probes. It will be appreciated that any of a variety of probe types and configurations can be used with the preferred embodiment of the invention. Additionally, the probe may be comprised of a single probe or of multiple probes. Preferably the probes used with audiometer 101 are intelligent probes. As used herein, intelligent probe is defined as a probe that includes the ability to communicate probe information to the instrument to which it is attached (e.g., audiometer 101) in addition to that information commonly communicated via a probe such as stimulus signals and/or response data. The additional information communicated via the intelligent probe can be calibration data, configuration data (e.g., probe capabilities), system operation information, etc.

Preferably audiometer 101 includes a short range wireless networking subsystem, thus allowing audiometer 101 to communicate with other correspondingly enabled devices and/or systems that are within the subsystem's range. Examples of such devices and systems include computers, printers, and networks. Typically the range of such a short range wireless networking subsystem is on the order of 30 feet or less although other ranges are possible (e.g., 100 feet or less, 500 feet or less, 1000 feet or less, etc.). The short range wireless networking subsystem includes a transceiver and can utilize any of a variety of networking technologies and protocols, as long as the selected system provides suitable networking capabilities between audiometer 101 and the desired device or system. Examples of suitable technologies and standards include Bluetooth and IEEEE802.11. As such technologies and standards are well know in the art (see, for example, the specifications found at www.bluetooth.com, www.standards.ieee.org/getieee802/802.11.html and www.grouper.ieee.org/groups/802/11/, all of which are incorporated herein by reference), further description will not be provided herein.

Coupled to audiometer 101 are multiple speakers 107-111. It will be appreciated that both fewer and greater numbers of speakers can be used, the primary competing factors being the quality of the created sound field versus the complexity/cost of the system. For example, additional speakers may create a more uniform and therefore more realistic sound field.

Speakers 107-111 can be directly coupled (i.e., wired) to audiometer 101 or they can be wirelessly coupled as in the preferred embodiment.

In the preferred embodiment, speakers 107-111 can be automatically calibrated by audiometer 101. During calibration, preferably a microphone is coupled to audiometer 101, the microphone then being located in the intended listener/patient position (e.g., position 115 in FIG. 1). Alternately, if audiometer 101 is portable, the microphone can be mounted within the audiometer and the audiometer itself can be positioned at the intended listener/patient position.

In order to calibrate the system, the speakers (e.g., speakers 107-111) are first located in appropriate positions around the intended listener/patient position. For a system comprised of five speakers as shown, two speakers (i.e., speakers 107 and 108) are placed behind and to either side of the intended listener/patient position; two speakers (i.e., speakers 109 and 111) are placed in front of and to either side of the intended listener/patient position; and one speaker (i.e., speaker 110) is placed directly in front of the intended listener/patient position. Preferably the speakers are located approximately at ear level. Although careful placement of the speakers can minimize the need for calibration, calibration is still required in order to account for environmental acoustics, speaker non-uniformities, mistakes in speaker placement, etc.

During calibration, preferably audiometer 101 determines ambient noise levels, speaker characteristics, and the environmental acoustics or characteristics. Part of the calibration routine is directed to obtaining proper individual speaker level settings and time delays. A second part of the calibration routine causes noise (e.g., pink noise) and timing pulses to be emitted by each of the speakers. Based upon the signals received by the microphone, the individual channels are calibrated, for example using an internal multi-band equalizer.

As previously noted, speakers 107-111 can be used in conjunction with audiometer 101 to perform various audiometry tests. Additionally, speakers 107-111 in conjunction with audiometer 101 can be used to evaluate various features and characteristics associated with a particular hearing instrument and/or a style/type of hearing instrument, features and characteristics such as noise reduction, directionality, and frequency response adaptation. Additionally, the system of the invention can be used in a master hearing aid mode or as a hearing loss simulator. Additionally, the system of the invention can be used to simulate various “typical” sound environments, thus allowing the patient to experience the benefits of a specific hearing instrument or aid.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. An auditory test instrument comprising:
an audiometer;
a plurality of speakers, wherein said speakers are used during testing procedures and hearing instrument evaluation procedures; and
means coupled to said audiometer for calibrating said plurality of speakers.

2. The auditory test instrument of claim 1, wherein said audiometer further comprises:
at least one test probe;
a power supply for supplying power to the auditory test instrument;
a diagnostic subsystem coupled to said at least one test probe, said diagnostic subsystem adapted to implement at least one auditory diagnostic test;
input means adapted to accept commands from a user;
a display adapted to display results from said at least one auditory diagnostic test; and
at least one processor coupled to said diagnostic subsystem and to said input means.

3. The auditory test instrument of claim 2, wherein said power supply is portable and does not require connection to an external power source.

4. The auditory test instrument of claim 2, wherein said audiometer further comprises a wireless networking subsystem adapted to wirelessly transmit first signals via a short distance wireless network to a peripheral electronic device or system and adapted to receive second signals via said short distance wireless network from said peripheral electronic device.

5. The auditory test instrument of claim 2, wherein said at least one probe is detachably coupled to said audiometer.

6. The auditory test instrument of claim 2, wherein said at least one probe is an intelligent probe.

7. The auditory test instrument of claim 2, wherein said at least one probe further comprises a memory, wherein probe calibration data is stored in said memory, said probe calibration data automatically communicated to said audiometer upon coupling said at least one probe to said audiometer and providing power to said audiometer.

8. The auditory test instrument of claim 2, wherein said at least one probe further comprises a memory, wherein probe configuration data is stored in said memory.

9. The auditory test instrument of claim 8, wherein said probe configuration data is automatically communicated to said diagnostic subsystem and wherein said at least one auditory diagnostic test is automatically selected in response to said probe configuration data.

10. The auditory test instrument of claim 3, wherein said power supply is rechargeable.

11. The auditory test instrument of claim 3, wherein said power supply is rechargeable via a contactless recharging system.

12. The auditory test instrument of claim 4, wherein said wireless networking subsystem is a Bluetooth enabled wireless networking subsystem and wherein said peripheral electronic device or system is a Bluetooth enabled electronic device or system.

13. The auditory test instrument of claim 4, wherein said peripheral electronic device or system is a LAN system.

14. The auditory test instrument of claim 4, wherein said peripheral electronic device or system is a device selected from the group of devices consisting of computers, personal digital assistants, printers, facsimile devices, and cellular telephones.

15. The auditory test instrument of claim 2, further comprising a memory, wherein said commands accepted by said input means select a test profile stored in said memory.

16. The auditory test instrument of claim 2, further comprising a memory, wherein said commands accepted by said input means provide access to patient data stored in said memory.

17. The auditory test instrument of claim 2, further comprising a memory, wherein said commands accepted by said input means provide access to office management tools stored in said memory.

18. The auditory test instrument of claim 2, wherein said display is selected from the group of displays consisting of liquid crystal displays, light emitting polymer displays, electroluminescent displays, active matrix electroluminescent displays, organic thin film transistor displays, organic light emitting diode displays, amorphous silicon integrated displays, and pliable display technology displays.

19. The auditory test instrument of claim 2, wherein said plurality of speakers are comprised of five speakers.

20. The auditory test instrument of claim 2, wherein said plurality of speakers are wirelessly coupled to said audiometer.

21. A method of calibrating an auditory test instrument, comprising the steps of:
coupling a plurality of speakers to an audiometer;
coupling a microphone to said audiometer;
automatically emitting a plurality of frequencies and timing signals through each of said plurality of speakers, wherein said automatic emitting step is controlled by said audiometer;
automatically calculating speaker levels and timing delays for each of said plurality of speakers, wherein said automatic calculating step is controlled by said audiometer; and
automatically calibrating individual speakers with a multi-band equalizer, wherein said automatic calibrating step is controlled by said audiometer and wherein said multi-band equalizer is integrated into said audiometer.
